(19) United States
(12) Patent Application Publication
(10) Pub. No.: US 2012/0241701 A1
(43) Pub. Date: Sep. 27, 2012

(54) Automated RV Support Leg Adjustment System

(76) Inventor: Daniel Krones, Mission Viejo, CA (US)

(21) Appl. No.: 13/432,397

(22) Filed: Mar. 28, 2012

Related U.S. Application Data
(63) Continuation of application No. 12/301,986, filed on Nov. 21, 2008, now abandoned.
(60) Provisional application No. 60/803,955, filed on Jun. 5, 2006.

(51) Int. Cl. B60S 9/02

(52) U.S. Cl. 254/418

(57) ABSTRACT

An auxiliary system for operating at least one motor operatively connected to first and second legs of a 5th Wheel RV comprising a calibration system that stores level position angular displacement data when the 5th Wheel RV is in a substantially level position and disconnect position angular displacement data when the 5th Wheel RV is in a disconnect position, a disconnect system stores pre-disconnect position angular displacement data immediately prior to disconnection of the 5th Wheel RV from the vehicle and operates the first and second motors based on the disconnect position angular displacement data and pre-disconnect position angular displacement data to displace the 5th Wheel RV to allow the 5th Wheel RV to be detached, and a leveling system operates the first and optionally second motors based on the level position angular displacement data to place the 5th Wheel RV in a substantially level position.

This application (Attorney Docket No. P216935) is a continuation of U.S. patent application Ser. No. 12/301,986, filed Nov. 21, 2008. The '986 application was a 371 of PCT/US07/12975 filed Jun. 1, 2007. The '975 PCT application was filed within one year of, and claimed priority to Provisional Application Ser. No. 60/803,955, filed Jun. 5, 2006. The subject matter of the foregoing related applications are incorporated herein by reference.

### BACKGROUND

1. Technical Field

This invention relates generally to the automation of the time-consuming, repetitive processes that are involved in connecting, disconnecting and leveling recreational vehicles (RV's) from the RV's tow truck.

2. Description of Related Art

The following description of the related art references the drawing shown in FIGS. 1 and 2. FIG. 1 is a side view of a conventional truck 2 and fifth wheel RV 1. FIG. 2 is a front view of the conventional fifth wheel RV of FIG. 1 also depicting the device of the present invention (item 7) attached thereto.

A fifth wheel style RV 1 is connected to it's (fifth wheel) tow truck 2 by attaching its goose-neck 3 to a trailer hitch typically located in the bed of a truck 2 above the rear wheels and axle. This type of connection (as compared to travel trailers which connect on a ball style hitch at the rear of the vehicle) provides better mechanical stability, better maneuverability and better ground clearance.

In order to disconnect, reconnect and level the RV 1 there are a number of steps the user must go through. The first part of the procedure involves lowering the RV's support legs 5 by mechanically pulling out a pin on each leg 5, dropping the legs 5 to an appropriate height and replacing the pin. The second part of the procedure involves pushing a button 4 that controls a motor which in turn drives the up and/or down movement of the support legs 5 under the weight of the RV 1. Because the RV 1 is so heavy, the motor 6 is geared down so that a small motor can move the enormous weight. Additionally, the wires connecting the motor to its battery power source are usually not more than 8-12 average size for practicality reasons. The combination of limited current and geared-down drive train on the motor 6 severely limits the maximum up/down speed of movement of the RV 1 (by the legs 5). Because of this limited speed, the user can spend several minutes or more pushing and holding a button 4 while waiting for the RV 1 to be raised or lowered to the desired position. To compound the issue, this several minute delay must be repeated each and every time the user wishes to connect, disconnect or level the RV 1.

A detailed description of each step the user must go through to achieve the second part maneuvering is described above as follows:

1. Parking and Disconnect. The user first drives the RV 1 to a location that can provide the most level area to park in. The RV 1 is then leveled manually from side to side by placing blocks, ramps or other spacers under the appropriate wheel. The next step is to disconnect the RV 1 from the fifth wheel tow truck 2. This is accomplished by manually lowering the RV's support legs 5 until the legs 5 are nearly touching the ground. Then the user presses the “Up” switch 4 on the RV 1 which starts a motor 6 turning to drive the support legs 5 further. Eventually the support legs 5 will contact the ground and begin transferring weight from the fifth wheel truck 2 to the support legs of the RV 1. The user must watch carefully to see at what moment the weight has been fully transferred to the support legs 5. If the user stops lowering the legs 5 too soon then the goose neck 3 will not be able to be disconnected from the truck 2. The user can tell when it is time to stop raising the RV 1 by watching the truck's hitch for a gap to appear between the gooseneck plate 3 on the RV 1 and the truck hitch plate. Once they see this gap appear then they can release the switch 4, which stops the motor. The user then unlocks the hitch and drives the truck 2 away.

2. Final Leveling. Once the truck 2 and RV 1 have been disconnected, it is time to lower the RV 1 to its front-to-back level position. This is accomplished by the user pressing the “Down” button 4 on the RV 1. This action starts the motor 6 turning in the opposite direction to the previous step, which in turn slowly lowers the front of the RV 1. After a minute or two, the RV 1 will be near its front-to-back level position. If the user has installed a bubble level or other level indicating device they can tell when the RV 1 is level and then can let go of the motor button 4 at the appropriate time. If there is no such level-indicating device, then the user must use their eye or other technique for achieving a level stopping position. At this point, the user is freed up for other activities.

3. Preparing for Hitching. When it is time to go, the user must reconnect the truck 2 to the RV 1. The first step in achieving this task is to raise the RV 1 back to it's original disconnect height. The user once again presses the RV's “Up” button 4 and waits for the RV's motor to move its support legs 5 down (and the RV 1 up). When the RV 1 gets near to the appropriate height, the user must typically back the truck 2 into position. This procedure is tricky in that the user must align the truck's hitch both horizontally and vertically to better than 1 inch accuracy. This maneuver can be further complicated if lighting is poor (such as at night). Once the truck is aligned horizontally, if the user finds the RV 1 at the wrong height, they must either get out of the truck 2 to be able to readjust the RV's height by pushing the up/down buttons 4, or have someone else assist in this process. Once the truck hitch and RV's gooseneck 3 are aligned, the user can lock the hitch and RV together.

4. Re-hitching. The next step in the reconnecting procedure is to retract the RV's legs 5 to travel height, which also transfers the weight from the RV's support legs 5 to the truck. This task is accomplished by the user once again pressing the RV's “Down” button 4, which causes the motor 6 to raise the support legs 5. The user must hold the button 4 for a minute or two and wait for the slow moving legs 5 to fully retract. Once the legs 5 have been retracted as far as possible by the motor 6, the user then mechanically retracts the legs 5 further by pulling their pins, manually moving the legs 5 up and then replacing the pins. The fifth wheel RV and truck reconnection procedure is now complete.

The speed at which the motor can move the RV's legs up and down varies but the process is generally time-consuming. Furthermore, other factors can prolong the process even more, such as lighting, weather, lack of available (skilled) help, etc. It is conceivable that an entire connect, disconnect and leveling procedure from start to finish could vary from as little as 15 minutes to as much as 45 minutes or more. Not to mention that whenever the user needs to perform a connect, disconnect or leveling procedure they need to repeat this time-consuming process over and over again.

Many RV users are traveling on vacation and are interested in rest and relaxation. Other RV users are in a hurry to either get on the road again to their next location or are anxious to get to sleep after traveling all day. Needless to say, the time consuming procedures involved in connecting, disconnecting and leveling a fifth wheel RV are not conducive to stress free, easy going travel.

### SUMMARY

In light of the aforementioned problems associated with the prior devices, methods and systems, it is an object of the present invention, to provide an Automated RV Support Leg Adjustment System. Accordingly it is a general object of the present invention to provide an improved process for connecting, disconnecting and leveling an RY. It is a more particular object of the present invention to provide a method for automating the time consuming process of the user having to press and hold a button while waiting for the slow movement of the RV to achieve the desired position.

In accordance with the present invention, there is provided an automated RV support leg adjustment system comprising: means for calibrating a known level position; means for controlling the movement of the RV's support legs motor; means for detecting and measuring support leg motor current (or other means for preventing leg over-extension or retraction); means for tracking the absolute mechanical up/down position of the RV's legs; means for detecting angular position with respect to the earth's gravitational vector; means for storing position and timing information; means for accepting user commands; means for indicating system status to a user; and means for controlling the action of the system in accordance with the users desires and tasks of connecting, disconnecting and automatically leveling an RV.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is a side view of a conventional truck and fifth wheel RV;

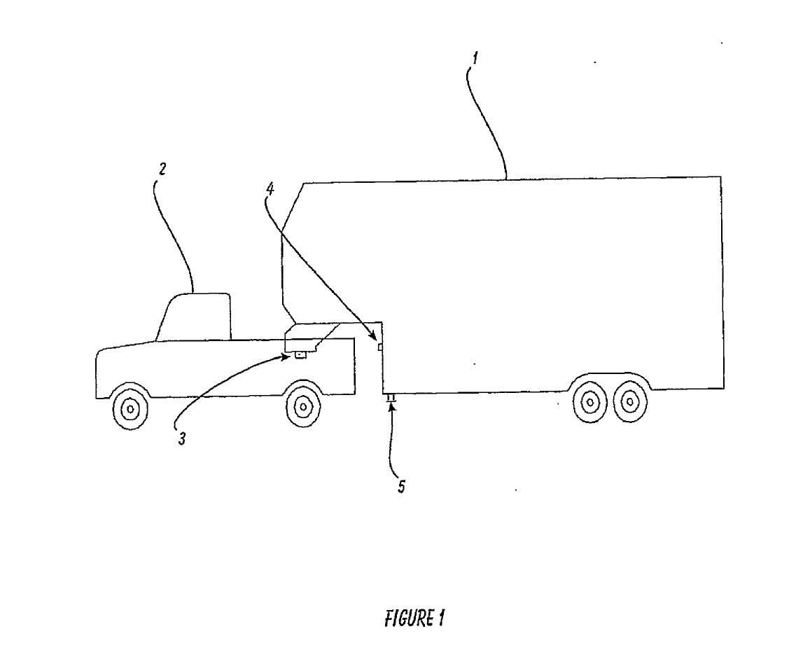

FIG. 2 is a front view of the conventional fifth wheel RV of FIG. 1;

FIG. 3 is a block diagram electrical schematic showing the primary functional blocks of a preferred embodiment of the present invention;

FIG. 4 is a perspective view of the device of FIG. 3;

FIG. 5 is a flowchart depicting the preferred embodiment of a first time use procedure using the present invention;

FIG. 6 is 5 flowcharts depicting the preferred embodiment of calibration procedures using the present invention;

FIG. 7 is a flowchart depicting the preferred embodiment of a system idle mode using the present invention;

FIG. 8 is a flowchart depicting the preferred embodiment of a method for automatically leveling a fifth wheel RV using the present invention;

FIG. 9 is a flowchart depicting the preferred embodiment of a method for automatically moving the fifth wheel RV legs into a “Retract” position using the present invention;

FIG. 10 is a flowchart depicting the preferred embodiment of a method for automatically moving the fifth wheel RV into a “Disconnect” position using the present invention;

FIG. 11 is a flowchart depicting the preferred embodiment of a method for automatically moving the fifth wheel RV into a “connect” position using the present invention;

FIGS. 12A and 12B are 2 flowcharts depicting the preferred embodiment of a method for moving the RV up or down using the present invention in a non-automated way; and

FIG. 13 is a flowchart depicting the preferred embodiment of a method for handling system error conditions using the present invention.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide an Automated RV Support Leg Adjustment System.

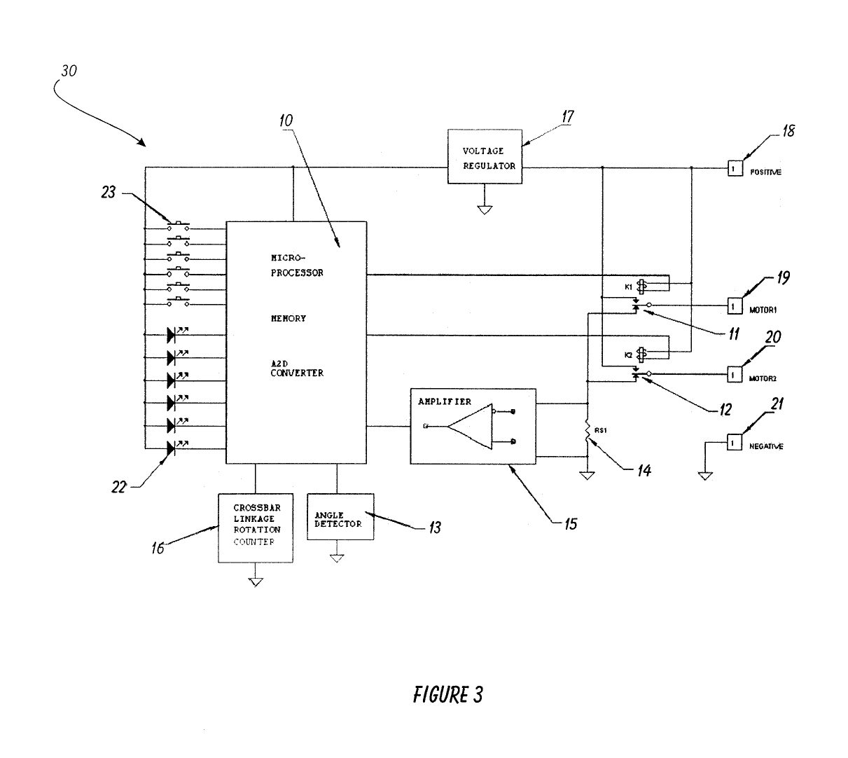

The present invention can best be understood by initial consideration of FIG. 3. FIG. 3 sets forth a block diagram of the RV support leg adjustment system 30 of the present invention, which has four connections to a typical RY. Connection 18 goes to the RV's positive battery terminal. Connection 21 attaches to the RV's negative battery terminal and together with connection 18, provides a 12V power source with which to operate the electronic circuitry of the present invention. Connection 19 goes to one wire of the RV's support legs motor. Connection 20 goes to the other motor wire, and these two connections coupled to the circuitry of the present invention can control the up and down rotational movement of the RV's support legs motor.

Connection 18 is attached to a voltage regulator 17 that converts the 12V power coming from the RV's battery into a voltage suitable to operate the electronic circuitry of the present invention.

Additionally, connection 18 is attached to motor relays 11 and 12 which are further connected to current sense resistor 14, completing an electrical path back to the RV's negative battery terminal which is connected to the present invention 30 at location 21. When either of the relays 11, 12 are energized, they connect the RV's battery to the RV's support legs motor the same way the RV's manually operated switch would, which causes the motor to turn one direction or the other depending upon which relay is energized. The present invention consists of the following basic elements:

1. Motor control means. Two relays, 11 and 12, wired in an “h-bridge” configuration. The same functionality could be provided by transistors or other electronically controlled components that are capable of performing a similar function.

2. Processor means. A microprocessor 10 including analog to digital conversion capability and non-volatile memory capability. These circuit components can be replaced by individual or discrete components wired to provide the same functionality.

3. Motor current measurement means. The depicted embodiment of the present invention 30 detects the voltage drop across resistor 14 (RSI) as a means to monitor the motor current. This voltage drop is amplified by amplifier 15 and then converted into a numeric value by the processor's built-in analog to digital converter. This current measurement means is intended to detect motor overload, when the legs have become fully retracted. An alternate approach that has been successfully demonstrated is to attach a magnetic switch sensor to one or both of the extension legs that will trigger the processor to interrupt power to the electric motor (thereby stopping the motor from retracting the legs).

4. Angle measurement means. The depicted embodiment of the present invention 30 uses an electrolytic tilt sensor 13. However, many other means of angular measurement are capable of providing the same functionality, such as “mems”-style capacitive sensors, electro-mechanical pendulum type systems, among others.

5. RV support leg mechanical position measurement means. The depicted embodiment of the present invention 30 uses infrared a photo reflective sensor 13 attached to the RV's support legs crossbar linkage (the bar tying the left leg and right leg together). This sensor 13 can accurately detect mechanical position of the support legs by counting reflected pulses as the square tube crossbar linkage rotates during normal operation of the system. This information, combined with directional information allows the processor to accurately determine the absolute extend/retract position of the RV's support legs. Many other means for detecting the position of the RV's support legs are possible including magnetic sensors, non-ir photo sensors, acoustic sensors, mechanical switches, etc. These sensors including the one being employed in the present invention can also be mounted on the RV legs directly instead of on the crossbar linkage to achieve similar results. As discussed above, in another embodiment, the mechanical leg position sensing will be replaced by a level sensor that can detect not only a true level condition, but also the angular displacement from level (or from some other benchmark angular condition). The over-retraction protection could be provided by the sensor/switch also discussed above.

6. Switch input means. The depicted embodiment of tile present invention 30 uses momentary on/off pushbuttons 23, however other types of buttons, switches and the like can provide the same functionality.

7. Indicator means. The depicted embodiment of the present invention 30 uses LED lights 22, however, LCD, incandescent lamps or other indicator means can provide the same functionality.

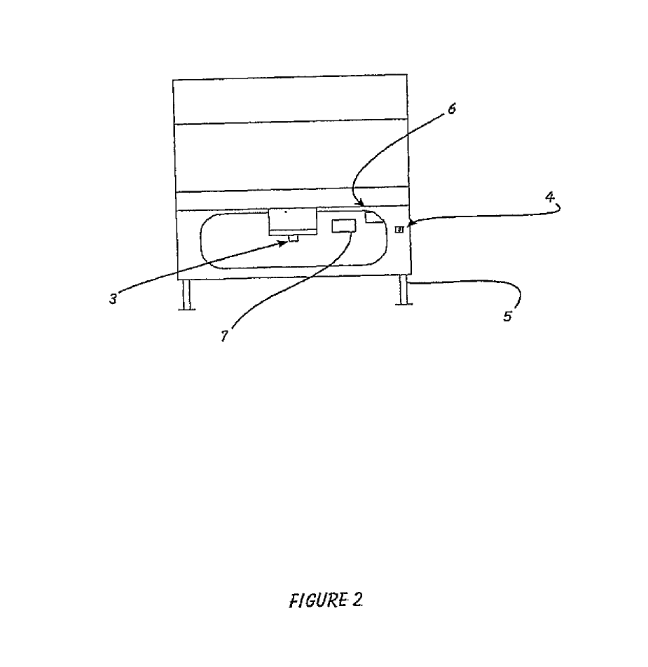

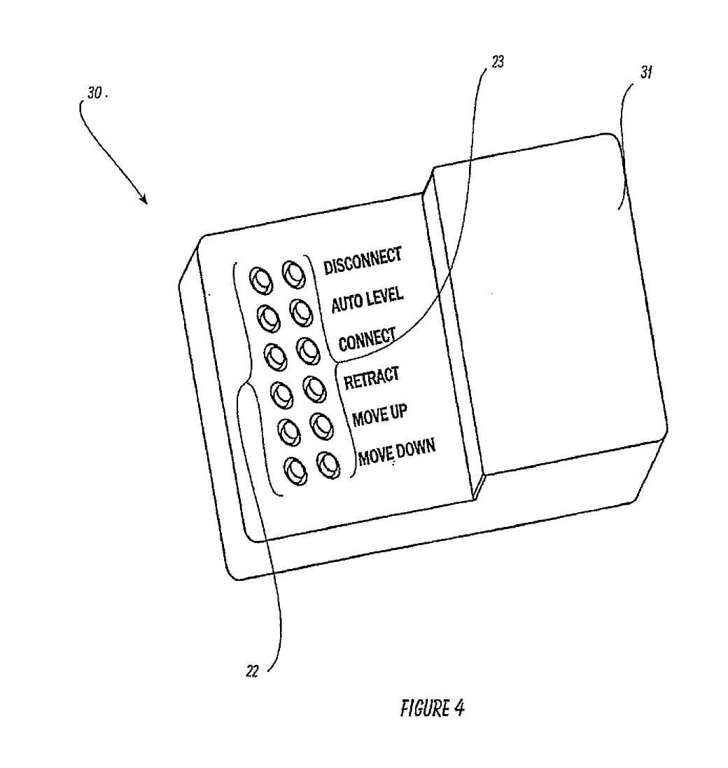

FIG. 4 is a perspective view of the device of FIG. 3. The System 30 is preferably contained within a weather resistant housing 31 that is mounted near the motor and battery of the RV (see FIG. 2). The controls could be presented in a variety of ways, but the depicted approach has proven to be durable and easy to use. Each operational pushbutton 23 is disposed on the housing 31 adjacent to a corresponding LED Light 22, with each button's function being inscribed next to the button 23. The functionality of each special-purpose button 23 will be discussed fully below in connection with the other drawing figures.

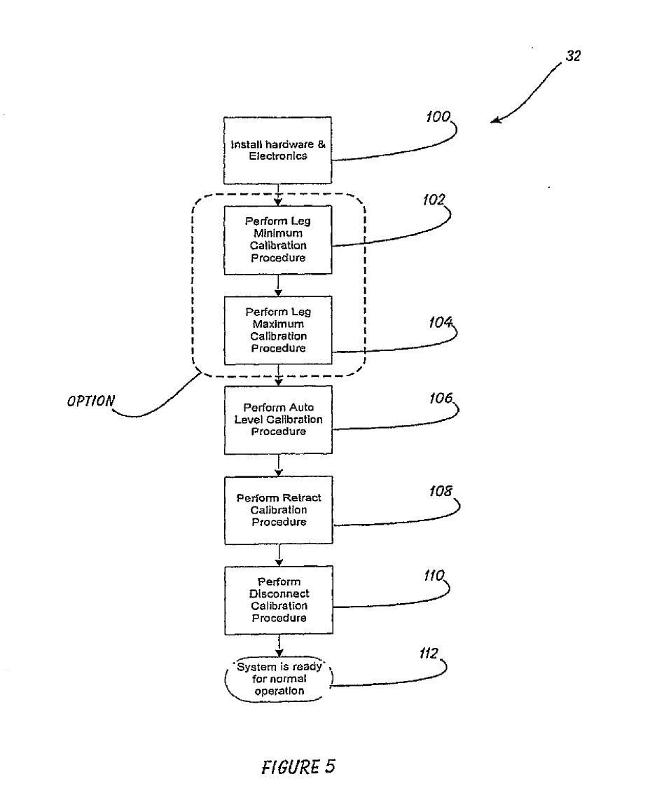

FIG. 5 is a preferred embodiment of the method for installing and initializing 32 the system of the present invention. Step 100 is the installation of the hardware and electronics comprising the system of the present invention. The installation of this product is important to the operation of the system. This system must be installed in the front of an RV preferably in the area directly above the RV's support legs 5. This is where the motor 6 and manual up/down switches 4 are located. The design of this particular version system's pc board must be installed in an orientation that is perpendicular to the ground in order for the internal level detection circuitry to operate correctly. However, this same functionality can be achieved by mounting the level detection component in other configuration and then compensating for it by changing the pcb board mounting orientation. The point is that it must be mounted in a way consistent with proper operation of the present invention, whichever direction it may be.

The system's housing must be installed securely to the RV to ensure that normal vibration from driving will not loosen the system from the RY. If the system moves relative to the RV after it has been calibrated, then the calibration values will not be accurate and the system will have to be recalibrated.

Steps 102-110 should be performed following installation of the hardware to prepare the system for use. Once each of these calibration processes have been completed, the system is ready for normal operation.

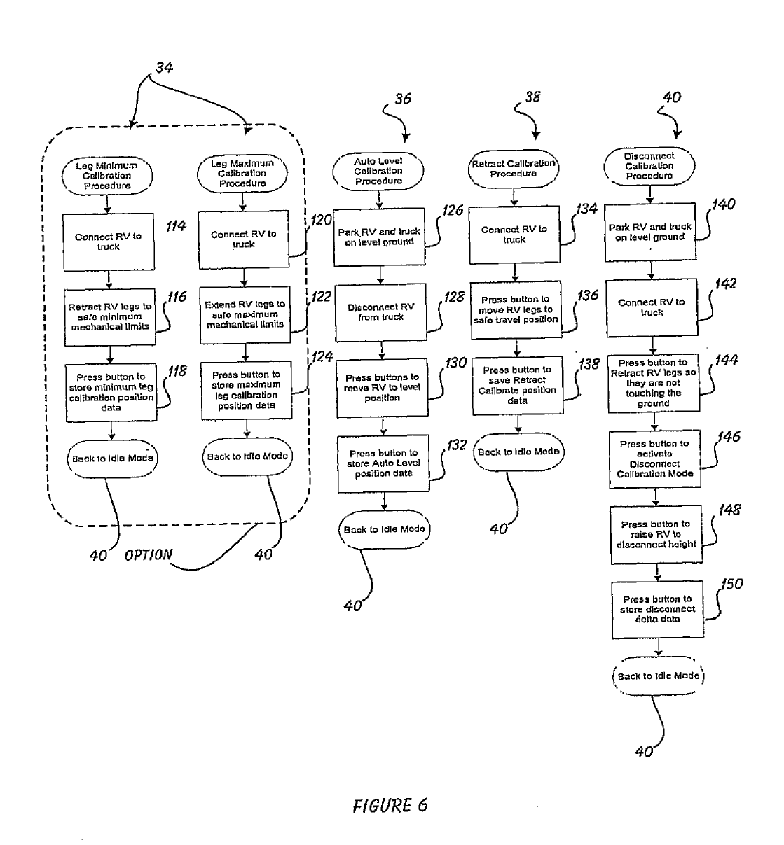

The minimum leg retraction distance and the maximum leg extension distances are the distances that the RV legs can be safely extended or retracted before they hit the mechanical limits. It is important to record these distances so the present invention will not try to force the legs up or down beyond their safe limits. To achieve this, the 2-step process 34 discussed in connection with FIG. 6 is required. First 104, the user must connect the RV to the truck, and then by pressing the manual move switch of the present invention the RV support legs are moved to a safe minimum mechanical limit position 116. This should be an inch or two away from the safety demarcation line indicated on the RV support leg by the leg manufacturer. Once the leg is in position, the user presses a button on the present invention to record the position in system memory 118. The second sequence of this process is similar but records the maximum leg extension position instead, and is depicted in flowchart steps FIG. 6, 120-124. The other calibration modes can occur in any sequence after these, but for safety purposes, the min and max travel distances for the RV legs are recorded first.

An alternate to calibrating the minimum leg extension (step 102), it is also possible to add the magnetic switch arrangement discussed above to simply trigger the processor to deactivate the drive motor. Implementing such a switch-activated over-retraction protection would eliminate the need for step 102.

It has further been determined that step 104, calibrating the maximum leg extension, is typically unnecessary if the device's level sensor is programmed to not only detect a level or out of level condition, but also to detect an “overtilt” condition. 11Ie RV will be driven by the legs to tilt the RV too far back before the legs will become overextended. As such, the processor is simply preset to detect this over-tilt condition and responsively deactivate the drive motor. While the tilt sensor has a maximum range of sensitivity it is still possible for the system to over extend the legs beyond their mechanical range if the terrain the RV is parked on is on a steep decline and the user does not extend the mechanically adjusted part of the legs far enough. In this case the mechanical limit of the leg can be reached before the tilt sensor gets out of range. If that happens, the gears in the leg will bind and the clutch between the motor on the gearbox will (hopefully) slip. This is an unusual circumstance and should not normally be experienced.

The next calibration sequence 36 is to record the Auto Level position. The user first parks the RV on level ground 126 and disconnects the RV from the truck 128. The user then manually levels the RV 130 using the manual mode up/down buttons 23 and presses a button on the present invention to activate Auto Level Calibrate Mode 132. The system then responsively saves the RV's angular position in nonvolatile memory.

The next calibration sequence 38 is to record the optimum travel position of the RV legs. The travel position is that position where the legs are fully retracted so that they are safe for traveling. The user first connects the RV to the truck 140, and then presses the manual mode up/down switches until the RV support legs are in the desired travel position 136. The user then presses the appropriate button on the present invention to activate Retract Calibrate Mode 138, after which the system stores the leg retract position in nonvolatile memory. Alternatively, a system using the aforementioned over-retraction mechanical limit switch arrangement would not require a calibration on the retract mode, since retraction would simply continue until the limit switch closes, which tells the processor to cease retraction (i.e. when the legs are in their fully retracted position).

The last calibration sequence 40 is to store the disconnect delta. The “discolll1ect delta” is the difference in support leg extension length between when the RV is fully connected to the truck and when the RV is in position to be disconnected from the truck. It is important to record this delta so that the system knows how far to move the RV up from the truck when the automated process of disconnecting the RV from the truck is activated.

The sequence 40 must begin with the RV and truck on level ground 140. The user then connects the RV to the truck's hitch 142, and begins this calibration procedure by using the systems up/down buttons to retract the RV legs so they are not in contact with the ground 144. The next step is to press a button on the present invention to activate Discolll1ect Calibrate Mode 146. This action stores the RV's present angular position into RAM. The user then raises the RV to the discolll1ect position using the up/down buttons until the RV is in the correct position 148. When the user presses the appropriate button on the invention 150, the system will execute a calculation that subtracts the starting position stored in step 146 from the present position (of step 148) to find the distance traveled (the disconnect delta). Once this calculation has completed, the present invention stores the discolll1ect delta value in non-volatile memory.

Both the connect and disconnect conditions for the RV can also be detected by the system's level sensor; the connect position and the disconnect position for the RV each correspond to a unique angular position for the RV, which can be detected by the level sensor.

These aforementioned calibration steps depict information gathering necessary for operation of the present invention. The exact sequence and button pushing for gathering this information is not critical. What is important is that the information is obtained and is accurate. As this invention is developed, so will the method of calibrating the system. It is a goal of the present invention to acquire this calibration information in an efficient manner with an emphasis on making it easy for a user to accomplish the goal.

Once this calibration information has been obtained it is stored in the processor's non-volatile memory and should not have to be repeated, even if there is a loss of power to the system.

When the system is first tamed on it initializes all system variables. It then reads a specific location in memory to determine if it has ever been turned on before. If it has not been turned on before it initializes all memory locations. If it has been turned on before. the next step is to verify if the all calibration positions have been recorded. If not, the system indicates to the user that it has not been calibrated by blinking the appropriate LED; the system will wait for the user to begin the calibration procedure. If the system has been calibrated previously then the system immediately goes into an Idle Mode and waits for user input.

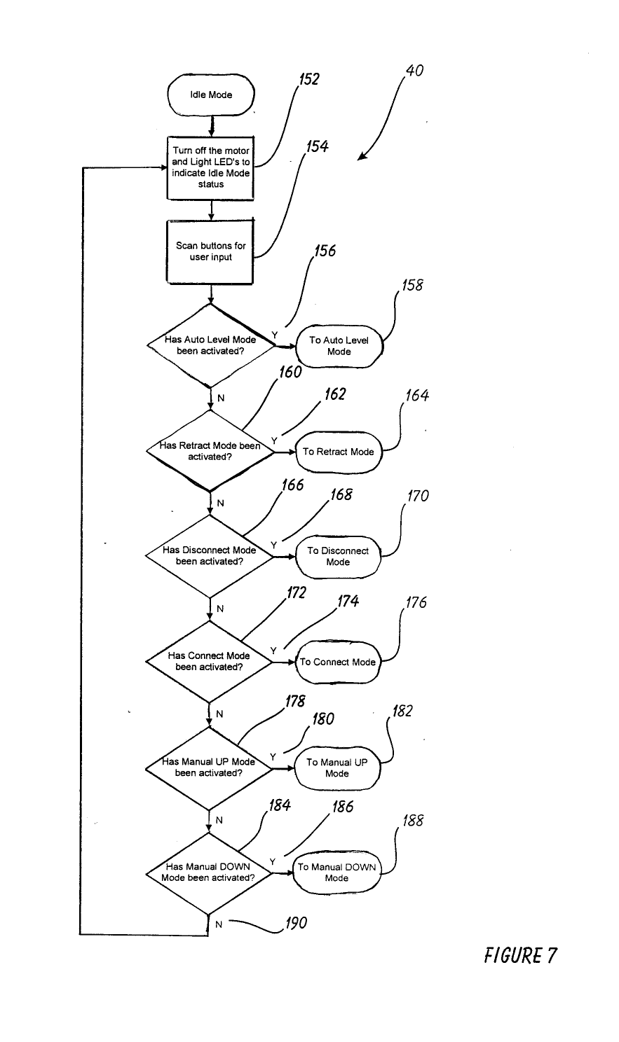

Under normal operation the system is in an “idle mode” state whereby it is performing no actions and waiting for user input. A flowchart depicting a preferred embodiment for idle mode 40 of the present invention is shown in FIG. 7. If the user presses any buttons, the button press is detected by the processor, which causes the processor to react accordingly. Typically a button press from the user causes the system to respond with an action and this action has an associated mode condition indicated to the user by lighting the appropriate LED and causing the RV's motor to run.

The generalized steps for idle mode operation begin at 152, wherein the system lights the appropriate LED(s) to indicate to the user that idle mode is active and that the system is waiting for a C0lll11land. During step 154, the processor scans the buttons for user input and processes the results in the subsequent steps. Step 156 determines if Auto Level mode has been activated and proceeds to Auto Level Mode 158 if it has. Otherwise 160, step 162 determines if Retract Mode has been activated and proceeds to Retract Mode 164 if it has. Otherwise 166, step 168 determines if Disconnect Mode has been activated and proceeds to Disconnect Mode 170 if it has. Otherwise 172, step 174 determines if Connect Mode has been activated and proceeds to COlll1ect Mode 176 if it has. Otherwise 178, step 180 determines if the manual UP Mode has been activated and proceeds to Manual UP Mode 182 if it has. Otherwise 184, step 186 determines if manual DOWN Mode has been activated and proceeds to Manual DOWN Mode 188 if it has. If no buttons have been pressed 190, the system loops back to step 152 and starts over again.

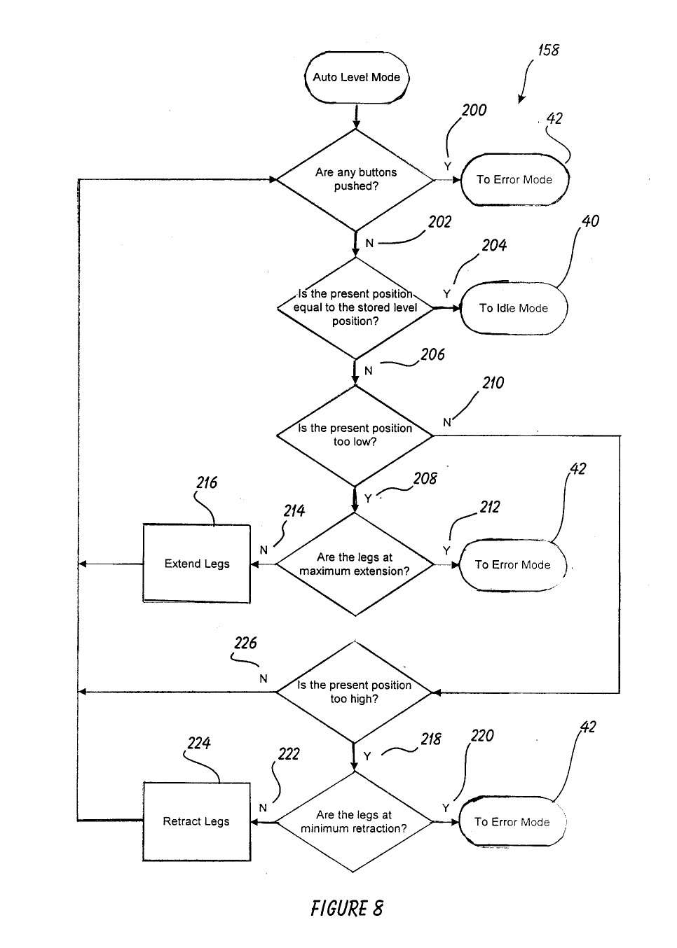

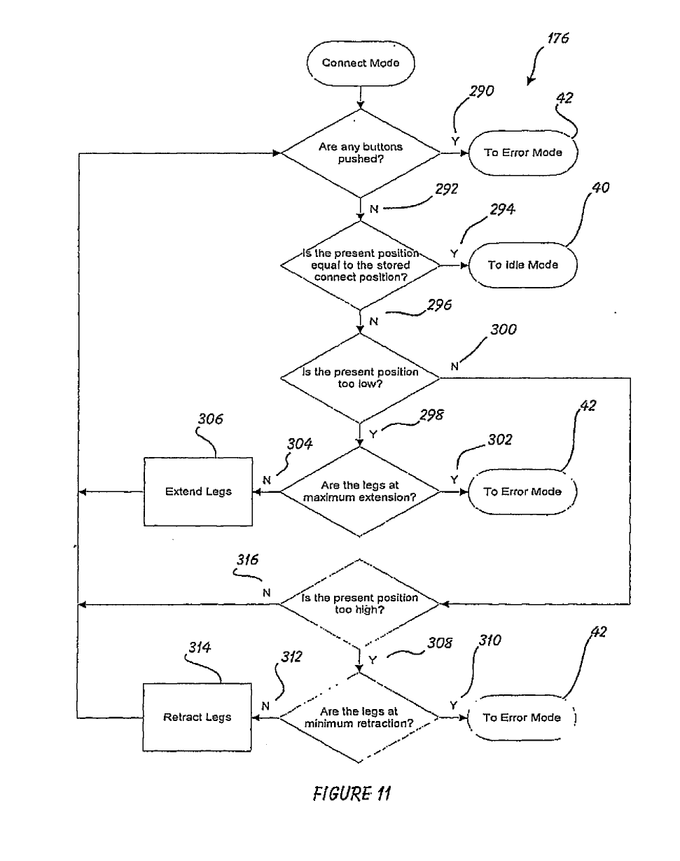

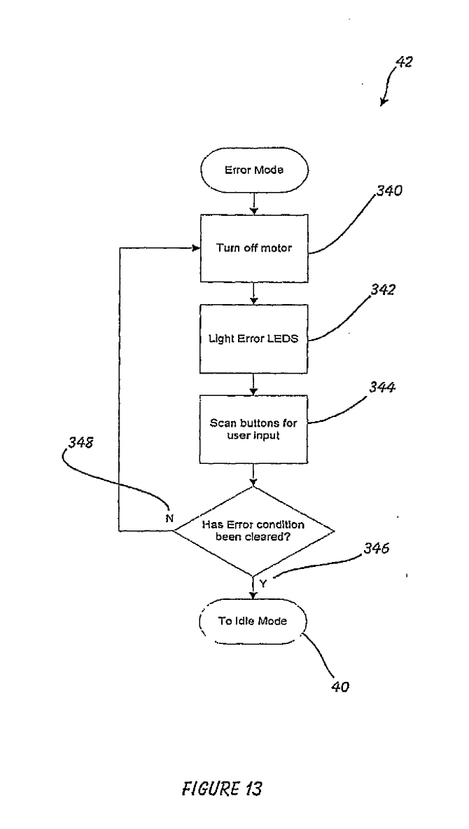

There are 6 user modes of operation. These user modes are detailed in FIGS. 8-12. FIG. 13 is an Error mode, which is automatically activated by the system if an error condition is detected.

As depicted in FIG. 8, once Auto Level Mode 158 has been activated, pressing any button 200 immediately cancels the mode (158), and the system proceeds to Error Mode 42. Otherwise 202, the system determines if it has reached the target position 204. If the target position has been reached, then the system proceeds to Idle Mode 40. Otherwise 206, the system determines if the present position is too low 208. If the present position is too low then it proceeds to detect whether the legs are at maximum extension, otherwise 210 it moves on to detect whether the RV position is too high. If, after determining that the position is too low (208), the system determines that the legs have reached their maximum extension 212, the system proceeds to Error Mode 42. If the leg extension is not at maximum 214 then the system extends the legs further 216, which raises the angular position (i.e. raises the front end) of the RV.

If the present position is too high 218 then the system determines whether or not the RV legs have reached a minimum retraction distance 220. If the legs are at minimum retraction then the system proceeds to Error Mode 42. If not 222, then the system retracts the legs further 224, which lowers the angular position of the RV (i.e. the front end). After the legs are either extended 216 or retracted 224, or if the position is neither too high nor too low (226), the system will loop back to the beginning, determining whether or not any buttons are pushed 200, 202, respectively. This loop will be repeated until the RV has reached the desired position.

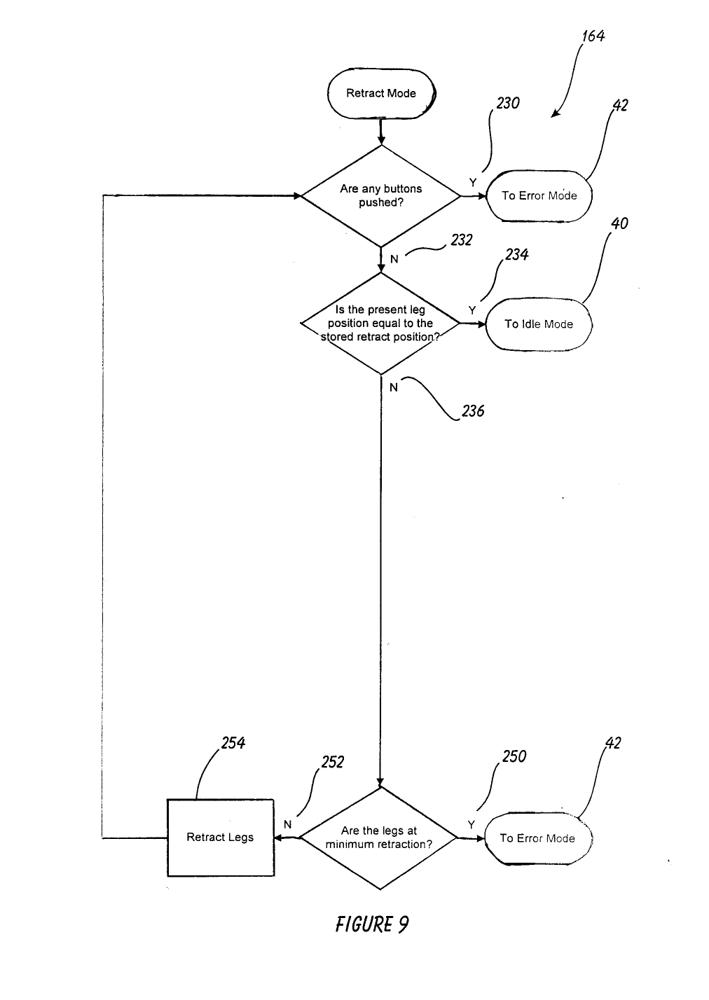

As depicted in FIG. 9, once Retract Mode 164 has been activated, pressing any button 230 immediately cancels the mode (164), and the system proceeds to Error Mode 42. Otherwise 232, the system determines if it has reached the target (retracted) position. If the target position has been reached 234, then the system proceeds to Idle Mode 40. Otherwise 236, the system determines if the legs are at minimum retraction or not (Le. are they fully retracted). If they are fully retracted 250, the system will go into error mode 42. If the legs are not fully retracted 252, the legs will retract 254. This loop will be repeated until the RV has reached the desired position.

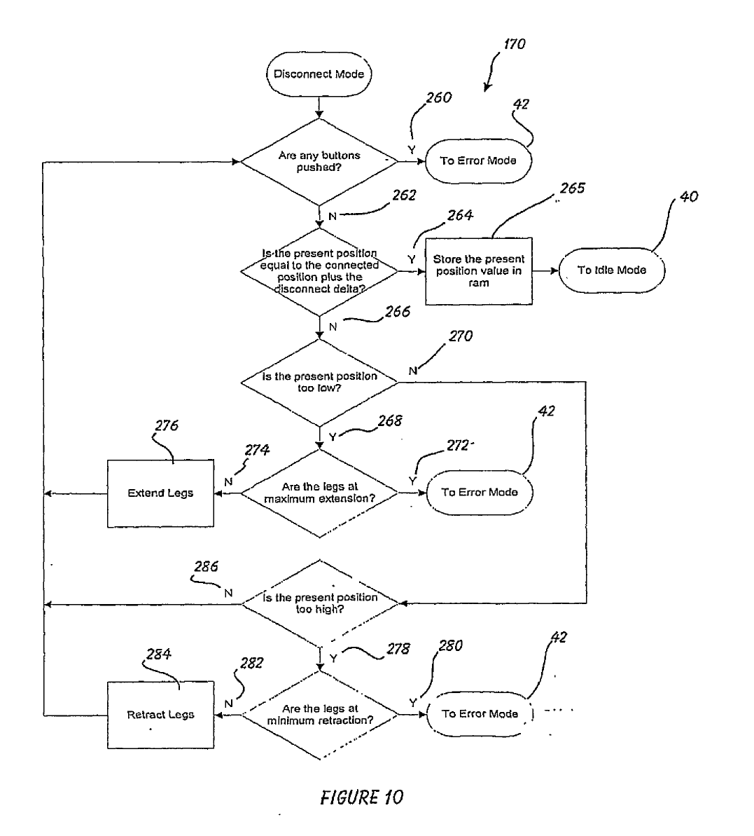

As depicted in FIG. 10, once Disconnect Mode 170 has been activated, pressing any button 260 immediately cancels the mode (170), causing the system to proceed to Error Mode 42. Otherwise 262, the system determines if it has reached the target position (connected position plus the disconnect delta). If the target position has been reached 264, then the system stores the present position value in memory 265 and then proceeds to Idle Mode 40. Otherwise 266, the system determines if the present position is too low. If the present position is too low 268, then it proceeds to detect whether or not the legs are at maximum extension; otherwise 270 it moves on to determine whether or not the present RV position is too high. If the support legs have reached maximum extension 272, then the system proceeds to Error Mode 42. If the leg extension is not at maximum 274, then the system extends the legs further 276, which raises the angular position (i.e. the front) of the RV If the present position is too high 278, then the system determines whether or not the RV legs have reached a minimum retraction distance. If the legs are at minimum retraction 280 then the system proceeds to Error Mode 42. If not 282, then the system retracts the legs further 284, which lowers the angular position (i.e. the front) of the RV After the System completes steps 276, 286 and 284, it will loop back to the beginning and will repeat the procedure until the RV has reached the desired position.

As depicted in FIG. H, once Connect Mode 176 has been activated, pressing any button 290 immediately cancels the mode (176), causing the system to proceed to Error Mode 42. Otherwise 292, the system determines if it has reached the target position (the RV position for connecting to the tow vehicle) or not. If the target position has been reached 294 then the system proceeds to Idle Mode 40. Otherwise 296, the system determines if the present position is too low or not. If the present position is too low 298 then it proceeds to determine whether the legs are at maximum extension or not, otherwise 300 it moves on to detect whether the RV position is too high. If the legs have reached maximum extension 302, then the system proceeds to Error Mode 42. If the leg extension is not at maximum 304, then the system extends the legs further 306, which raises the angular position (i.e. the front) of the RV If the present position is too high 308, then the system determines whether or not the RV legs have reached a minimum retraction distance. If the legs are at minimum retraction 310, then the system proceeds to Error Mode 42. If not 312, then the system retracts the legs further 314, which lowers the angular position (i.e. the front end) of the RV After the System completes steps 306, 316 and 314, it will loop back to the beginning and will repeat the procedure until the RV has reached the desired position.

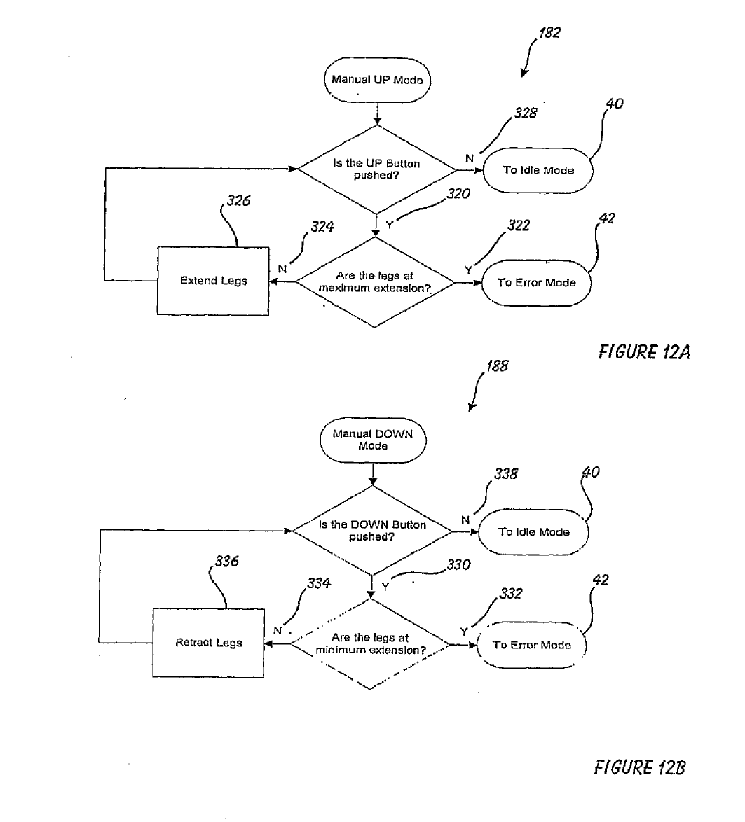

As depicted in FIG. 12A, Manual UP Mode 182 emulates the motor up switch of a conventional 5th wheel RV (Le. the manual control). As long as the button is pressed and held 320 and no error condition exists 322, the system will run the motor and move the RVup (324, 326). If the Up button is no longer pressed 328, the system returns to Idle Mode 40. Otherwise 320, the system determines whether the extension of the legs has reached maximum. If the leg extension has reached the maximum 322, then the system proceeds to Error Mode 42. If the leg extension is not at maximum 324, then the system extends the legs further 326, which raises the angular position (the front) of the RV After completing the leg extension 326, the system loops back to the beginning step and repeats the procedure until the user lets go of the Up button or an error condition has been met.

As depicted in FIG. 12B, Manual Down Mode 188 emulates the motor down switch of a conventional 5th wheel RV As long as the button is pressed and held and no error condition exists, the system will run the motor and move the RV down. If the Down button is no longer pressed 338, the system returns to Idle Mode 40. Otherwise 330, the system whether the extension of the legs has reached the minimum amount possible. If the legs are fully retracted (i.e. minimum extension) 332, then the system proceeds to Error Mode 42. If the leg retraction is not at its minimum 334, then the system retracts the legs further 336, which lowers the angular position (the front end) of the RV After retracting the legs 336, the system loops back to the beginning and repeats the procedure until the user lets go of the Down button or an error condition has been met.

Finally, as depicted in FIG. 13, Error Mode first turns off the motor 340. Next 342, the system lights LED's to indicate to the user that an error condition exists. The system scans the keyboard for user input 344, and then determines if a user has pressed a button to acknowledge and clear the error condition. If the user has pressed a button 346, then the system proceeds to Idle Mode 40. Otherwise 348, the system loops back to EM2 and repeats this mode.

The preceding descriptions of the various operating modes are the fundamental modes of which this system is capable. Each one of the automated modes can save a user time by running the motor, monitoring position data and automatically stopping when the system reaches a desired goal. The present invention describes a novel apparatus and method for automating the time consuming repetitive tasks associated with the processes of connecting, disconnecting and leveling a fifth wheel RV With some modification is may be possible to use some or all of the functionality described in the present invention to automate similar tasks for other vehicles such as large 18 wheeler style trucks and their cargo haulers or other types of RV's.

While particular embodiments of the present invention have been shown and described, it will be obvious to those skilled in the art that changes and modifications may be made without departing from the invention in its broader aspects. Therefore, the aim in the appended claims is to cover all such changes and modifications as fall within the true spirit and scope of the invention.

What is claimed is:

1. An auxiliary system for operating at least one motor operatively connected to first and second legs of a 5th Wheel RV, where the 5th Wheel RV is detachably connected to a vehicle, the auxiliary system comprising:
a calibration system that stores
level position angular displacement data when the 5th Wheel RV is in a substantially level position, and
disconnect position angular displacement data when the 5th Wheel RV is in a disconnect position relative to the vehicle;
a disconnect system that
stores pre-disconnect position angular displacement data immediately prior to disconnection of the 5th Wheel RV from the vehicle, and
operates the first and second motors based on the disconnect position angular displacement data and pre-disconnect position angular displacement data to displace the 5th Wheel RV to allow the 5th Wheel RV to be detached from the vehicle; and
a leveling system that operates the first and optionally second motors based on the level position angular displacement data to place the 5th Wheel RV in a substantially level position.

2. An auxiliary system as recited in claim 1, further comprising a connect system that operates at least one motor based on the disconnect position angular displacement data and the pre-disconnect position angular displacement data to allow the vehicle to be arranged in a pre-connect position relative to the 5th Wheel RV.

3. An auxiliary system as recited in claim 1, in which the connect system further operates at least one motor based on the disconnect position angular displacement data and the pre-disconnect position angular displacement data to reattach the 5th Wheel RV to the vehicle.

4. An auxiliary system as recited in claim 1, further comprising a microprocessor, where
the microprocessor is operatively connected to the motors; and
the calibration system, the disconnect system, and the leveling system are software modules operating on the microprocessor.

5. An auxiliary system as recited in claim 2, further comprising a microprocessor, where
the microprocessor is operatively connected to the motors; and
the calibration system, the disconnect system, the leveling system, and the connect system are software modules operating on the microprocessor.

6. An auxiliary system as recited in claim 1, further comprising an angle detector for generating angular displacement data based on an angular position of the 5th Wheel RV with respect to level.

7. An auxiliary system as recited in claim 4, further comprising an angle detector for generating angular displacement data based on an angular position of the 5th Wheel RV with respect to level, where the angle detector is operatively connected to the microprocessor.

8. An auxiliary system as recited in claim 1, in which the microprocessor is connected to a leg retraction sensor that can detect and report when the 5th Wheel RV legs are fully retracted.

9. An auxiliary system as recited in claim 1, in which the disconnect position angular displacement data is associated with a difference between the angular position of the 5th Wheel RV when the 5th Wheel RV is in the substantially level position relative to the earth and the angular position of the 5th Wheel RV when the 5th Wheel RV is in a disconnect position relative to the vehicle.

10. An auxiliary system as recited in claim 1, in which the disconnect position angular displacement data is a disconnect delta calculated based on the angular position of the 5th Wheel RV when the 5th Wheel RV is in the substantially level position and the angular position of the 5th Wheel RV when the 5th Wheel RV is in a disconnect position relative to the vehicle.

11. A 5th Wheel RV displacement system for displacing a 5th Wheel RV relative to a vehicle, the 5th Wheel RV displacement system comprising:
first and second leg assemblies operatively connected to the RV;
at least one motor operatively connected to the first and second leg assemblies;
an angle detector for generating angular displacement data indicative of an angular position of the 5th Wheel RV;
a processor operatively connected to the angle detector and at least one motor, where the processor operates in a calibration mode in which the processor stores
level position angular displacement data when the 5th Wheel RV is in a substantially level position relative to horizontal, and
disconnect position angular displacement data when the 5th Wheel RV is in a disconnect position relative to the vehicle;
a disconnect mode in which the processor
stores pre-disconnect position angular displacement data immediately prior to disconnection of the 5th Wheel RV from the vehicle, and
operates the first and second motors based on the disconnect position angular displacement data and pre-disconnect position angular displacement data to displace the 5th Wheel RV to allow the 5th Wheel RV to be detached from the vehicle; and
a leveling mode in which the processor operates the first and second motors based on the level position angular displacement data to place the 5th Wheel RV in a substantially level position with respect to the earth.

12. A 5th Wheel RV displacement system as recited in claim 11, where the processor further operates in a connect mode in which the processor operates the first and second motors based on the disconnect position angular displacement data and the pre-disconnect position angular displacement data to allow the vehicle to be arranged in a pre-connect position relative to the RV.

13. A 5th Wheel RV displacement system as recited in claim 11, in which, in the connect mode system, the processor further operates the first and optionally second motors based on the disconnect position angular displacement data and the pre-disconnect position angular displacement data to reattach the 5th Wheel RV to the vehicle.

14. A 5th Wheel RV displacement system as recited in claim 11, in which, in the microprocessor detects a signal sent by the leg retract sensor and operatively stops the first and optionally second motors from retracting when the legs are in the ideal position for connecting the RV.

15. A 5th Wheel RV displacement system as recited in claim 11, in which the disconnect position angular displacement data is associated with a difference between the angular position of the 5th Wheel RV when the 5th Wheel RV is in the substantially level position and the angular position of the 5th Wheel RV when the 5th Wheel RV is in a disconnect position relative to the vehicle.

16. A 5th Wheel RV displacement system as recited in claim 11, in which the disconnect position angular displacement data is a disconnect delta calculated based on the angular position of the 5th Wheel RV when the 5th Wheel RV in the substantially level position and the angular position of the 5th Wheel RV when the 5th Wheel RV is in a disconnect position relative to the vehicle.
